(19) United States
(12) Patent Application Publication
(10) Pub. No.: US 2008/0127761 A1
(43) Pub. Date: Jun. 5, 2008

(54) Parallel axis gear power transmission device

(75) Inventor: Yasushi Mineshima, Kurashiki-shi (JP)

Correspondence Address: SQUIRE, SANDERS & DEMPSEY L.L.P., 8000 TOWERS CRESCENT, 14TH FLOOR, TYSONS CORNER, VA, 22182-2700, US

(73) Assignee: Sumitomo Heavy Industries, Ltd.

(21) Appl. No.: 11/905,807

(22) Filed: Oct. 4, 2007

(30) Foreign Application Priority Data
Oct. 5, 2006 (JP) 2006-274312

(51) Int. Cl. F16H 1/06

(52) U.S. Cl. 74/413

(57) ABSTRACT

A power transmission device is provided which can fit into a main machine such as conveyors at low costs and can readily meet low-noise requirements as well. A parallel axis gear power transmission device accommodates, in a casing, a speed reduction section for reducing the rotational speed of an input shaft. The speed reduction section comprises a parallel axis gear mechanism. The casing is configured such that at least two flat surfaces are in contact with a virtual circle which can be drawn about an axial center of the output shaft, and the two flat surfaces are flared respectively toward the side on which the input shaft is present.

### BACKGROUND OF THE INVENTION

1. Field of the Invention

The present invention relates to a parallel axis gear power transmission device which is most suitable for use with material handling equipment, in particular, with conveyors such as chain conveyors, belt conveyors, or roller conveyors, and which can be installed in various manners and is light in weight, compact, and improved in efficiency.

2. Description of the Related Art

When a main machine such as a conveyor is driven, a power transmission device disposed between a drive source such as a motor and the drive shaft of the main machine may be equipped with an orthogonal transform mechanism (for example, see the publication of U.S. Pat. No. 5,203,231).

This is because such a situation often occurs where a motor is typically longer in its axial direction, and therefore, for example, the axial direction of the motor can be changed to an orthogonal direction thereto, thereby allowing it to be installed in a reduced area.

In particular, for a power transmission device of this type, prime importance is placed on such a design that allows the size from the axial center of the output shaft to a particular radially outermost circumferential portion of the power transmission device to be reduced as much as possible. This is because a reduction in the size makes it possible to shorten, for example, the distance from the output shaft of the power transmission device to the upper surface of the conveyor (the upper chain surface, the upper roller surface, and the upper belt surface). This in turn allows the entire conveyor including the power transmission device to be reduced in size, and significantly facilitates designing cooperative movements of a plurality of arms and transfer operations between conveyors.

In the publication of U.S. Pat. No. 5,203,231, such a technique is disclosed in which the casing is formed generally in a cubic shape, and the relationship between the axial center of the output shaft, the position of mounting bolt holes, and the mountable surfaces is contemplated, thereby allowing the size from the axial center of the output shaft to a particular outer circumferential surface of the gear box to be significantly reduced.

However, a speed reduction mechanism of an orthogonal axis system is generally more expensive than a speed reduction mechanism of a parallel axis system, and the power transmission device itself is often not always easy to manufacture. In particular, as in the technique disclosed in the publication of U.S. Pat. No. 5,203,231, a hypoid speed reduction mechanism or the like with low noise and relatively high efficiency would be much more disadvantageous over the parallel axis system in terms of costs and ease of fabrication.

### SUMMARY OF THE INVENTION

The present invention was developed in order to solve these problems. It is therefore an object of the present invention to provide a parallel axis gear power transmission device which can fit into a main machine such as robots or conveyors at low costs and readily meet low-noise requirements as well.

The present invention provides a parallel axis gear power transmission device. The parallel axis gear power transmission device accommodates, in a casing, a speed reduction section for reducing the rotational speed of an input shaft. The speed reduction section is formed of one or plurality of parallel axis gear mechanisms. The casing is configured such that at least two flat surfaces are in contact with a virtual circle which can be drawn about an axial center of the output shaft, and the two flat surfaces are flared respectively by angles from the remaining surface toward the side on which the input shaft is present. This arrangement can solve the aforementioned problems.

The present invention basically employs not an orthogonal speed reduction mechanism which is inferior in point of cost but a speed reduction mechanism of a parallel axis system which is reduced in costs, requires no special assembly step, and (if necessary) can use a helical gear, thereby readily reducing noise. When a speed reduction mechanism of a parallel axis system is employed, (the motor shaft of) the motor is inevitably disposed in parallel to the drive shaft of a main machine such as a conveyor. However, according to the present invention, the shape of the casing is contemplated, thereby attempting to reduce the distance between the axial center of the output shaft of the parallel axis gear power transmission device and the axial center of the drive shaft of the main machine to a minimum. It is thus possible to address any problems with space-related issues (to be described later).

According to the present invention, it is possible to fit into a main machine such as robots or conveyors at low costs and (if necessary) readily meet low-noise requirements as well.

### BRIEF DESCRIPTION OF THE DRAWINGS

FIG. 1 is a front view showing a parallel axis gear power transmission device according to an exemplary embodiment of the present invention with each gear being incorporated into a first casing block of its speed reducer;

FIG. 2 is a developed cross-sectional view taken along line II-II of FIG. 1 when viewed from the arrows;

FIG. 3 is a rear view of the aforementioned power transmission device;

FIG. 4 is a front view of the aforementioned power transmission device;

FIG. 5 is a schematic diagram showing installation variations of the aforementioned power transmission device;

FIG. 6 is a view showing an exemplary comparative installation form of a power transmission device with a first flat surface and a second flat surface not flared;

FIG. 7 is a developed cross-sectional view, corresponding to FIG. 2, showing another exemplary embodiment of the present invention;

FIG. 8 is a front view corresponding to FIG. 4; and

FIG. 9 is a schematic front view showing still another exemplary embodiment of the present invention.

### DETAILED DESCRIPTION OF THE PREFERRED EMBODIMENTS

Hereinafter, one example of an exemplary embodiment of a parallel axis gear power transmission device according to the present invention will be described with reference to the attached drawings.

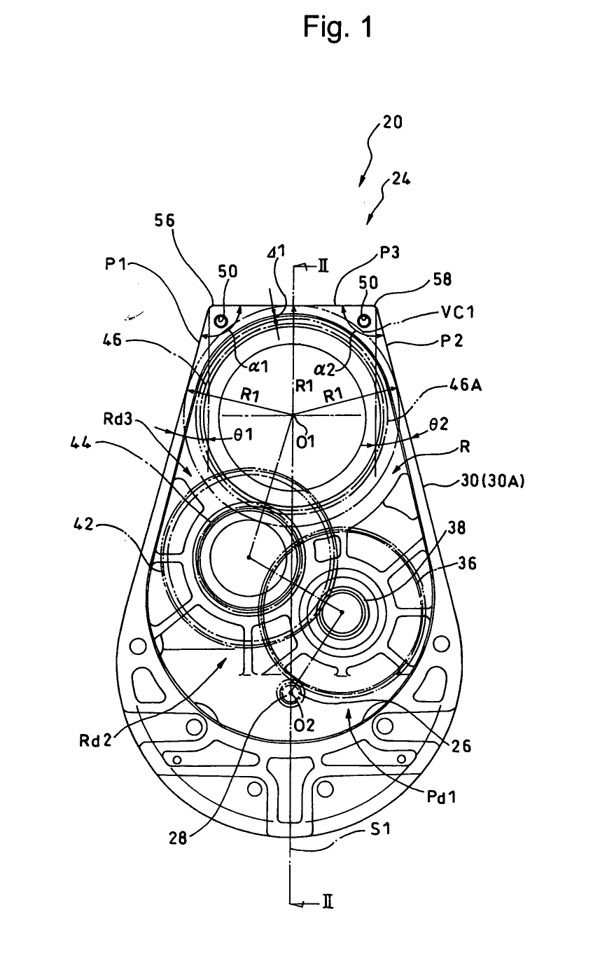

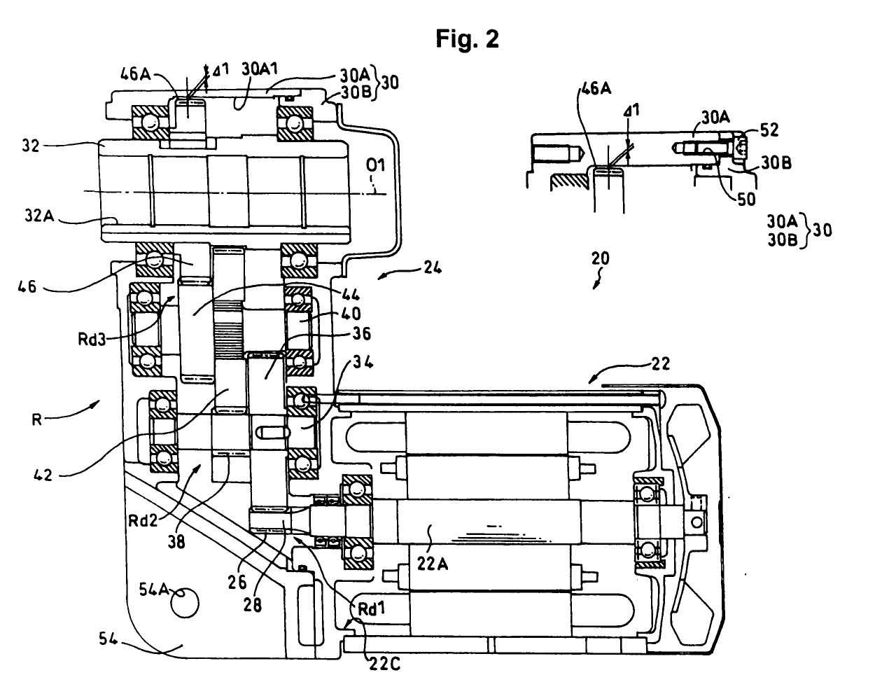

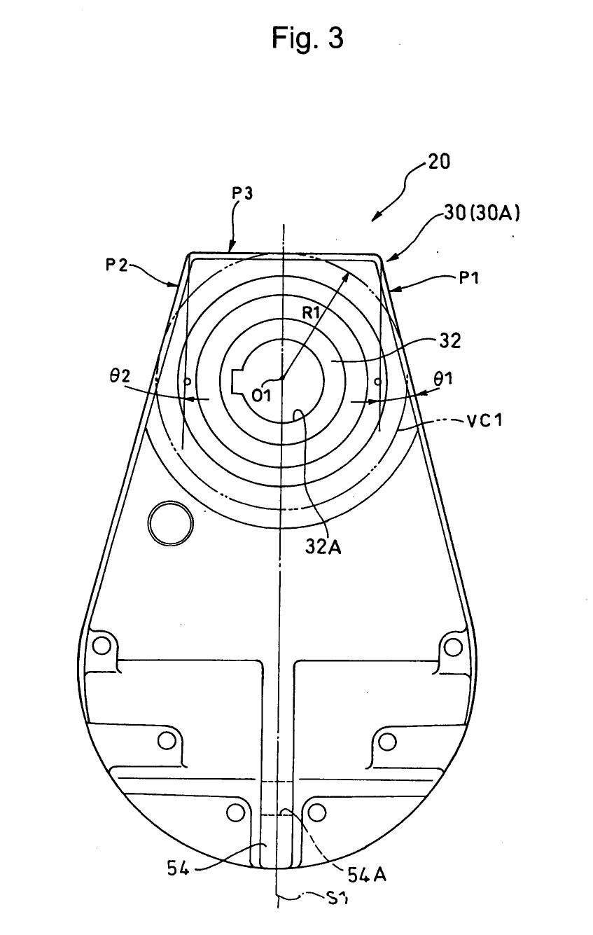

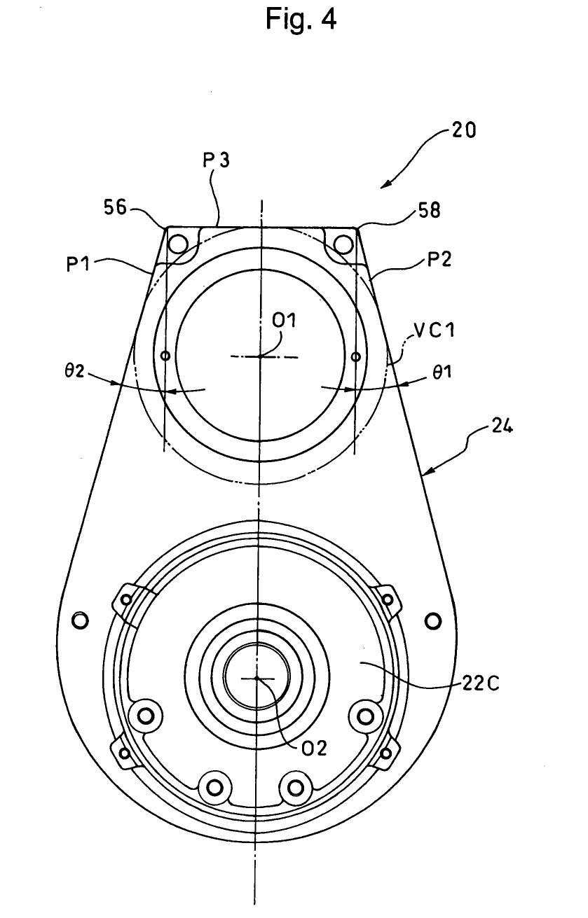

FIG. 1 is a front view showing how each parallel axis system is incorporated into a first casing block (to be described later) of a speed reducer of the parallel axis gear power transmission device. FIG. 2 is a developed cross-sectional view taken along line II-II of FIG. 1 when viewed from the arrows. FIG. 3 is a rear view of the parallel axis gear power transmission device (an outline view when viewed from the back side of the drawing of FIG. 1). FIG. 4 is a front view showing the parallel axis gear power transmission device when viewed from a position where a motor is installed, with an output shaft and the motor not shown.

First, with reference mainly to FIG. 2, a description will be made to the overall configuration.

This parallel axis gear power transmission device 20 is coupled with a motor 22 and a speed reducer 24. The motor 22 has a first helical pinion 26 on an end portion of a motor shaft 22A. The motor shaft 22A also serves as an input shaft 28 of the speed reducer 24.

The speed reducer 24 accommodates a speed reduction section R within a casing 30. The speed reduction section R reduces the rotational speed of the input shaft 28 to deliver it to an output shaft 32. The speed reducer 24 includes three stages of first to third parallel axis gear mechanisms Rd1 to Rd3. The first parallel axis gear mechanism Rd1 includes the first helical pinion 26 formed on the input shaft 28, and a first helical gear 36 which is formed on a first intermediate shaft 34 to mesh with the first helical pinion. The second parallel axis gear mechanism Rd2 includes a second helical pinion 38 which is rotated integrally with the first intermediate shaft 34, and a second helical gear 42 which is formed on a second intermediate shaft 40 to mesh with the second helical pinion 38. The third parallel axis gear mechanism Rd3 includes a third helical pinion 44 which is rotated integrally with the second intermediate shaft 40, and an output gear (a third helical gear) 46 which is formed on the output shaft 32 to mesh with the third helical pinion 44. The output shaft 32 is a hollow shaft having a through hole 32A formed along its axial center O1.

The rotation speed of the input shaft 28 is reduced in three stages by these first to third parallel axis gear mechanisms Rd1 to Rd3 and then transmitted to the output shaft 32. As can be seen clearly from FIG. 2, all the shafts including the input shaft 28 (the motor shaft 22A) and the output shaft 32 are parallel to each other.

The casing 30 includes two blocks, a first casing block 30A and a second casing block 30B, in the axial direction of the output shaft 32 (i.e., in the axial direction of all the shafts). As shown in an extracted portion at the upper right of FIG. 2, the blocks are coupled to each other by a bolt 52 bolted into a bolt hole 50.

With reference to FIG. 1, FIG. 3, and FIG. 4 together, the casing 30 is shaped so that its three flat surfaces (a first flat surface P1 to a third flat surface P3) are in contact with a virtual circle VC1 which can be drawn about the axial center O1 of the output shaft 32. That is, all the three flat surfaces P1 to P3 have an equal distance R1 to the axial center O1 of the output shaft 32. Additionally, two of the three flat surfaces P1 to P3 (the first flat surface P1 and second flat surface P2) are formed to be flared respectively by angles θ1 and θ2 with respect to a direction from the remaining one flat surface (the third flat surface P3) toward the side on which the input shaft 28 is present. Namely, the flat surface P1 and the flat surface P3 form an obtuse angle α1, and the flat surface P2 and the flat surface P3 form an obtuse angle α2. Note that in this exemplary embodiment, flaring angles θ1,θ2 are equal each other (θ1=θ2). That is, the first flat surface P1 and the second flat surface P2 are formed symmetrically with respect to a central plane S1 which contains both the axial center O2 of the input shaft 28 and the axial center O1 of the output shaft 32.

As can be seen clearly from FIGS. 1 and 2, only a very small gap, denoted by a symbol Δ1, is provided between an addendum circle 46A of the output gear 46 and an inner surface 30A1 (of the first casing block 30A) of the casing 30. Therefore, the casing 30 which is defined by the first flat surface P1 to the third flat surface P3 around the output gear 46 is designed to have as small a size as possible.

More specifically, in general, those gears on the input shaft 28 side (such as 26 and 36) are applied with low torque and thus formed in a small size, whereas those gears on the output shaft 32 side (in particular, the output gear 46) are applied with high torque and thus designed to have a large size. Thus, in a qualitative point of view, there is a more spatial allowance on the input shaft side rather than on the output shaft side relative to the casing 30 (i.e., the casing can be designed to decrease in size). However, the present exemplary embodiment is contemplated such that the output gear 46 is reduced intentionally to be generally the same in size as the first gear 36 so that the addendum circle 46A will not be increased in size. At the same time, the aforementioned flat surfaces are flared by angles θ1 and θ2, respectively, toward the input shaft side where there is more spatial allowance. With this configuration, the first flat surface P1 to the third flat surface P3 intersect each other at obtuse angles α1 and α2 (α1=α2 in the present exemplary embodiment) on intersecting lines 56 and 58. It is thus possible not only to reduce the radial size of the casing 30 around the output shaft 32 but also to ensure a much better fit into a main machine in a reduced area (to be described later).

It is preferable that the degree of the flaring (the flaring angles θ1 and θ2) is set within such a range that allows a motor of the maximum of various capacities capable of being combined with the speed reducer 24 to fit thereinto. That is, it should be set to such a magnitude that allows the maximum radial outer circumferential portion of the motor 22 to be housed inside the first flat surface P1 and the second flat surface P2. Note that symbol 54 in FIGS. 2 and 3 indicates a torque arm for fixing the parallel axis gear power transmission device 20 to a securing member of a main machine (not shown) to prevent its rotational displacement, and symbol 54A indicates a mounting hole provided on the torque arm 54. Furthermore, symbol 22C in FIG. 4 denotes a mounting hole for a motor.

A description will now be made to the operation of the parallel axis gear power transmission device 20 while describing the configuration of a chain conveyor 60 serving as a main machine into which the parallel axis gear power transmission device 20 is incorporated.

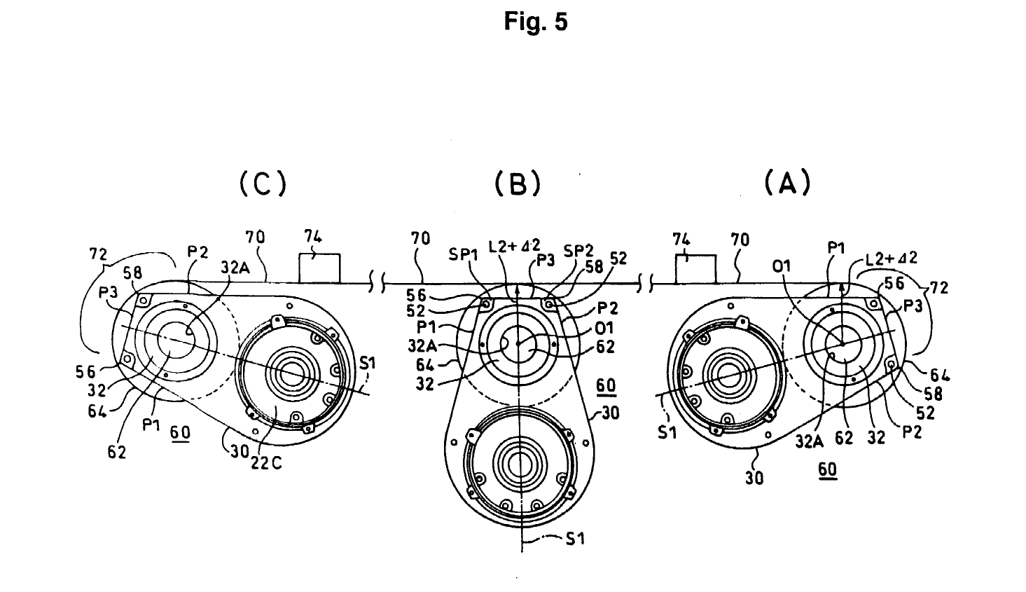

The parallel axis gear power transmission device 20 is incorporated into the chain conveyor 60 as shown in FIGS. 5(A) to (C). In the mounting step shown in FIG. 5(A), in order to fit it within the width of the chain conveyor 60, a drive shaft 62 is allowed to penetrate the through hole 32A of the output shaft 32 of the parallel axis gear power transmission device 20.

Then, the mount angle of the first flat surface P1 is adjusted such that the first flat surface P1 is parallel to an upper chain surface (an upper conveyor surface) 70 of the chain conveyor 60. Using the torque arm 54 (see FIGS. 2 and 3), the parallel axis gear power transmission device 20 is fixed to a securing member (not shown) of the chain conveyor 60 to prevent its rotational displacement. The rotation of the output shaft 32 of the parallel axis gear power transmission device 20 is transmitted toward the chain conveyor 60 via the drive shaft 62 of the chain conveyor 60 having been inserted in the through hole 32A, and via a sprocket (or a pulley) 64 which is provided on the drive shaft 62.

Note that the parallel axis gear power transmission device 20 must be mounted so that part of it will not protrude from the chain surface 70 and will not radially outwardly protrude from a round face 72 near the end portion. This is done so that a to-be-transported object 74 fed on the upper chain surface 70 will not interfere or collide mutually with the parallel axis gear power transmission device 20.

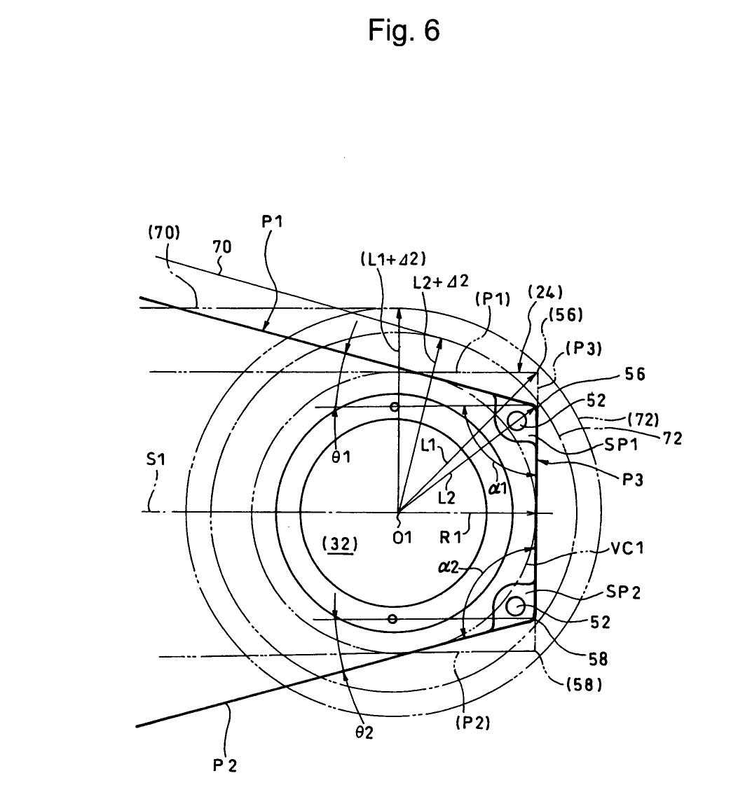

In the present exemplary embodiment, compact mounting to the chain conveyor 60 can be achieved relative to both the upper chain surface 70 and the round face 72. This effect results from the first flat surface P1 and the third flat surface P3, and the second flat surface P2 and the third flat surface P3 intersecting each other on the intersecting lines 56 and 58 at obtuse angles α1 and α2, respectively. FIG. 6 shows a comparative example. For example, a comparison is made with a speed reducer (24) which has the same virtual circle VC1 and has a second flat surface (P2) and a third flat surface (P3) intersecting each other at right angle. In the case of the speed reducer (24) wherein the second flat surface (P2) and the third flat surface (P3) intersect each other at right angle in this manner, a distance L1 between their intersecting line (56) or (58) and the axial center O1 of the output shaft 32 is twice as large as the square root of the radius R1 of the virtual circle VC1. Accordingly, the axial center O1 has to be located inevitably farther away from the upper chain surface (70) or a round face (72) (L1+Δ2). In contrast to this, the parallel axis gear power transmission device 20 according to the present exemplary embodiment allows the size from the axial center O1 of the output shaft 32 to the intersecting lines 56 and 58 to fall within a size L2+Δ2, which is slightly larger than the radius R1 of the virtual circle VC1. Since it is clear that L1>L2, the distance to the upper chain surface 70 or the round face 72 can be shortened by that amount (L1−L2).

Referring back to FIG. 5, the parallel axis gear power transmission device 20 is configured so that the first flat surface P1 and the second flat surface P2 are formed symmetrically with respect to the central plane S1 (which contains both the axial center O2 of the input shaft 28 and the axial center O1 of the output shaft 32). It is thus possible to provide exactly the same operational effect when mounting is carried out as shown in FIG. 5(C) (so that the second flat surface P2 is parallel to the upper chain surface 70).

Furthermore, as shown in FIG. 5(B), the third flat surface P3 may also be mounted in parallel to the upper chain surface 70. In this case, the parallel axis gear power transmission device 20 can be mounted so as to have the longest size in a direction perpendicular to the upper chain surface 70 (vertically in FIG. 5) and the shortest size in a direction parallel to the upper chain surface 70 (in the direction of travel or horizontally in FIG. 5). In this case, the distance between the axial center O1 of the output shaft 32 and the upper chain surface 70 can also fall within L2+Δ2. As a result, mounting can be carried out in three ways with respect to the upper chain surface 70 (or in six ways in total when those cases are included where the motor is mounted opposite to each of FIG. 5(A) to (C)).

Furthermore, any of these ways of mounting is carried out in a manner such that the parallel axis gear power transmission device 20 itself is suspended from the drive shaft 62 itself of the chain conveyor 60. The parallel axis gear power transmission device 20 will thus not protrude from the conveyor width of the chain conveyor 60 (the size in a direction orthogonal to the drawing surface of FIG. 5). Accordingly, the parallel axis gear power transmission device 20 can be mounted on the chain conveyor 60 without an excessive increase in width.

Furthermore, the output gear 46 is surrounded by the three flat surfaces (the first flat surface P1 to the third flat surface P3), thereby providing small spaces SP1 and SP2 near the two intersecting lines 56 and 58 on which the first flat surface P1 to the third flat surface P3 intersect each other. In these spaces, a total of two “appropriately sized” bolts 52 can be disposed to couple the first and second casing blocks 30A and 30B in parallel to the intersecting lines 56 and 58, respectively. The bolts 52 are subjected to shearing stress caused by such torque that acts via the torque arm 54 upon the first and second casing blocks 30A and 30B to rotate about the output shaft relative to each other. However, since two “appropriately sized” bolts 52 are provided, it is possible to ensure a sufficient strength.

Additionally, since the speed reduction section R is formed of a combination of a helical pinion and a helical gear of a parallel axis system, costs and noise are reduced and the fabrication step is simplified.

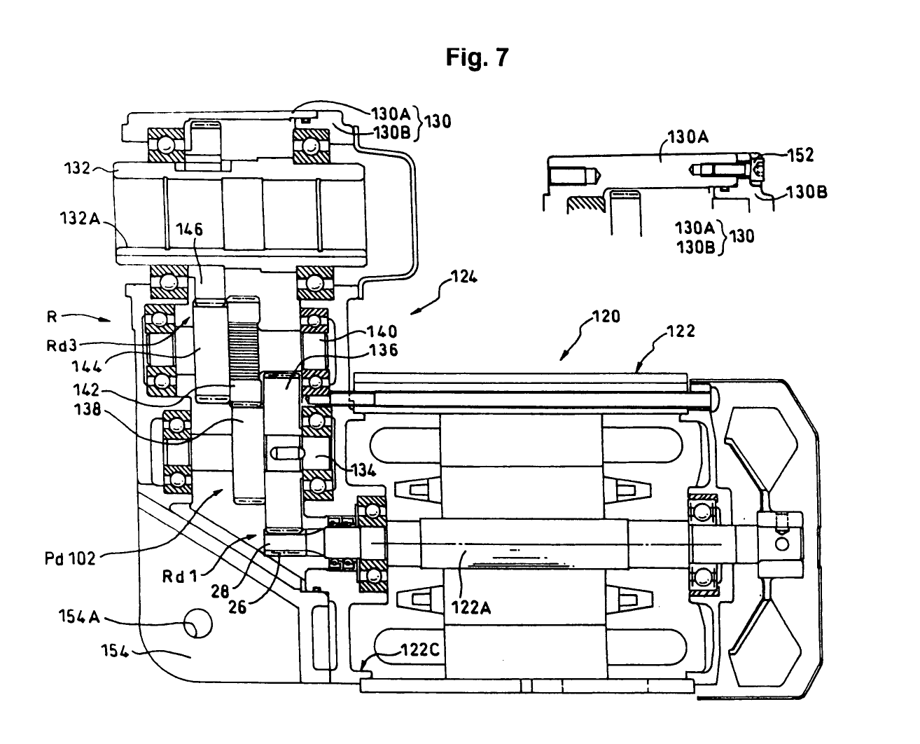

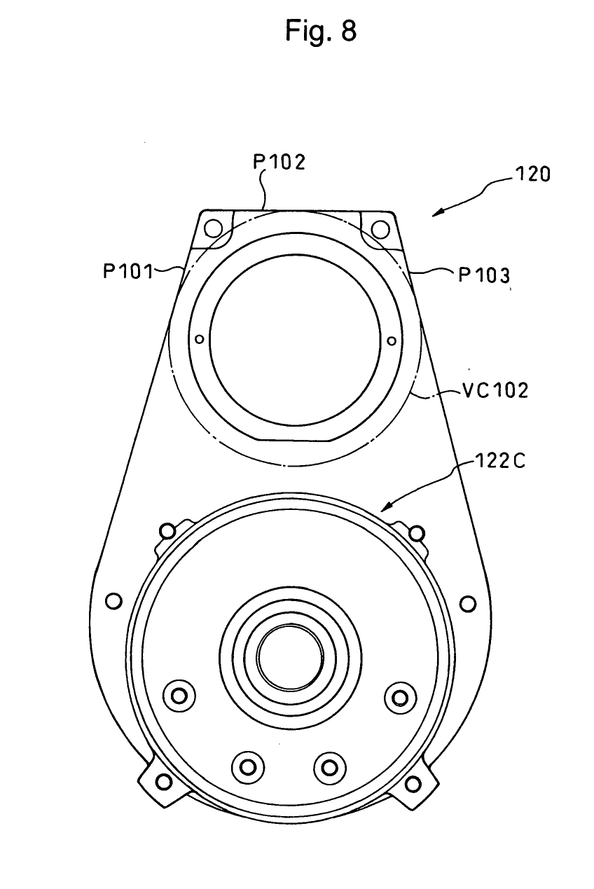

FIGS. 7 and 8 show another exemplary embodiment of the present invention.

This exemplary embodiment is configured basically in the same manner as the previous exemplary embodiment. They are different from each other in that the reduction ratio obtained by a second parallel axis gear mechanism Pd102 is slightly less than that of the previous exemplary embodiment to reduce the reduction ratio of the entire speed reducer 124. Furthermore, a motor 122, which is larger in size and more powerful than the motor 22 of the previous exemplary embodiment, is coupled thereto.

Many other members, however, are the same as those of the previous exemplary embodiment (members other than a second casing block 130B (in particular, its motor mounting hole 122C), a second helical pinion 138, a second helical gear 142, and the motor 122 are different from those of the previous exemplary embodiment). Additionally, even in this case, the maximum radial outer circumferential portion of the motor 122 is housed inside a first flat surface P101 and a second flat surface P102. Thus, for example, (while the motor 122 larger than the motor 22 according to the previous exemplary embodiment is employed), the mounting can be carried out exactly at the same position in the same manner even for the same chain conveyor (not illustrated) as that of the previous exemplary embodiment.

Since the other components are configured in the same manner as in the previous exemplary embodiment, the same or similar portions in the figure are only indicated with the same symbol with the same two lower digits and will not be repeatedly explained.

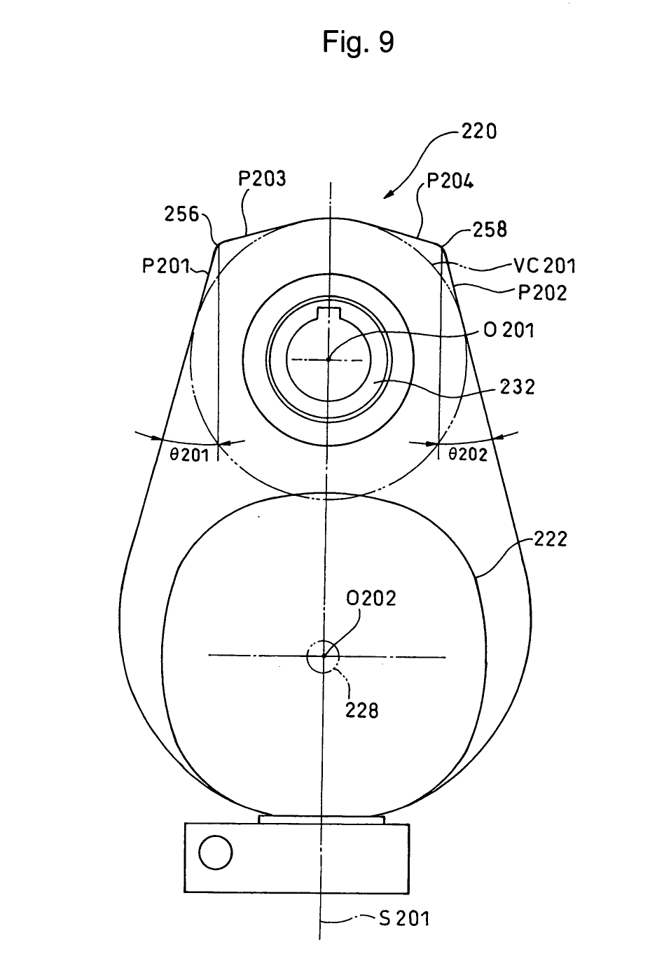

Now, FIG. 9 shows still another exemplary embodiment of the present invention.

A parallel axis gear power transmission device 220 according to this exemplary embodiment is configured such that four flat surfaces (a first flat surface P201 to a fourth flat surface P204) are in contact with a virtual circle VC 201 about the axial center O201 of an output shaft 232. Additionally, two flat surfaces of them (the first flat surface P201 and the second flat surface P202) are flared from the remaining two flat surfaces (the third flat surface P203 and the fourth flat surface P204) by angles θ201 and θ202 toward the side on which an input shaft 228 is present (θ201=θ202), respectively. These flared two flat surfaces (the first flat surface P201 and the second flat surface P202) are formed symmetrically with respect to a plane S201 which contains both the axial center O202 of the input shaft 228 and the axial center O201 of the output shaft 232. According to this exemplary embodiment, mounting can be carried out in eight ways with respect to a conveyor surface (not shown) or the like (in four ways where the flat surfaces P201, P202, P203, and P204 are disposed each in parallel to the upper conveyor surface and in the other four ways where the motor is oriented differently than in the former four ways). Additionally, even when the same output gear is mounted (the virtual circle VC 201 has the same size), the distance from the axial center O201 of the output shaft 232 to the upper conveyor surface (not illustrated) can be further shortened by the amount of a reduced portion which would protrude from the virtual circle. Since the other components are configured in the same manner as in the previous exemplary embodiment, the same or similar portions in the figure are only indicated with the same symbol with the same two lower digits and will not be repeatedly explained.

In any of the aforementioned exemplary embodiments, the casing around the output shaft is formed of three or four flat surfaces or “planes.” However, in the present invention, what is essential is only that a first flat surface and a second flat surface are flared in a plane. For example, those portions corresponding to the third flat surface and the fourth flat surface of the aforementioned exemplary embodiment may be formed in the same cylindrical shape as (or generally to be coaxial with) the output shaft.

It is possible to provide a parallel axis gear power transmission device which can fit into a main machine such as robots or conveyors at low costs and readily meet low-noise requirements as well.

The disclosure of Japanese Patent Application No. 2006-274312 filed Oct. 5, 2006 including specification, drawing and claim are incorporated herein by reference in its entirety.

What is claimed is:

1. A parallel axis gear power transmission device comprising:
a casing having at least two flat surfaces;
an input shaft;
an output shaft;
and a speed reduction section which is accommodated in the casing, reduces a rotational speed of the input shaft, and outputs a reduced rotational speed to the output shaft, wherein
the speed reduction section comprises a parallel axis gear mechanisms, and
the casing is configured such that at least the two flat surfaces are in contact with a virtual circle which can be drawn about an axial center of the output shaft, and the two flat surfaces are flared toward a side on which the input shaft is present.

2. A parallel axis gear power transmission device according to claims 1, wherein
the casing has three flat surfaces, and
the casing is configured such that the three flat surfaces are in contact with a virtual circle which can be drawn about an axial center of the output shaft, and two flat surfaces of them are flared from a remaining flat surface between the two flat surfaces toward a side on which the input shaft is present.

3. The parallel axis gear power transmission device according to claims 2, wherein
the casing includes two or more casing blocks in an axial direction of the output shaft, and bolts for coupling the casing blocks are disposed near two intersecting lines, along which the three flat surfaces intersect, in parallel to the intersecting lines.

4. The parallel axis gear power transmission device according to claim 1, wherein
the two flat surfaces are formed symmetrically with respect to a plane containing both an axial center of the input shaft and the axial center of the output shaft.

5. The parallel axis gear power transmission device according to claims 1, wherein
the output shaft is a hollow shaft having a through hole formed along the axial center thereof.

6. The parallel axis gear power transmission device according to claims 1, wherein
a motor for imparting drive to the input shaft is coupled to the casing, and a maximum radial outer circumferential portion of the motor is housed inside two planes each including one of the two flat surfaces.
